(19) United States
(12) Patent Application Publication
(10) Pub. No.: US 2007/0214159 A1
(43) Pub. Date: Sep. 13, 2007

(54) Processing data using date information

(75) Inventors: H. Richard Lawson, Dallas, TX (US); Richard D. Patton, St. Paul, MN (US); Michael Alexander Herrmann, St. Paul, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Lawson Software, Inc.

(21) Appl. No.: 11/369,607

(22) Filed: Mar. 7, 2006

(51) Int. Cl. G06F 7/00

(52) U.S. Cl. 707/101

(57) ABSTRACT

Methods and apparatus for processing data using date information are described herein. In one embodiment, an apparatus includes a record creation unit configured to create a database record. The database record can include a first field indicating past operations performed on the database record. The database record can also include a second field indicating future operations to be performed on the database record.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2006, Lawson Software, Inc.

### FIELD

Embodiments of the inventive subject matter relate generally to data processing, and more particularly to data processing using date information.

### BACKGROUND

Database users often use database management systems (DBMSs) for storing, organizing, and retrieving data in databases. Some databases store data as records, which include one or more data fields. Some databases organize data as relational tables made up of rows and columns, where each row represents a record and each column represents fields in the records.

DBMSs often use logs or journals for recording database changes. The logs can include records that store information about the database changes. DBMSs may retrieve log records for recovery purposes (e.g., such as rollback operations), security purposes (e.g., identifying illegal operations performed by unauthorized users), auditing purposes, or any other purpose that requires access to previous operations or data.

### BRIEF DESCRIPTION OF THE FIGURES

The present invention is illustrated by way of example and not limitation in the Figures of the accompanying drawings in which:

FIG. 1 is a diagram illustrating dataflow and operations for modifying a database record, according to embodiments of the invention;

FIG. 2 illustrates an example computer system used in conjunction with certain embodiments of the invention;

FIG. 3 is a block diagram illustrating a database record controller, according to example embodiments of the invention;

FIG. 4 is a block diagram illustrating database records, according to example embodiments of the invention;

FIG. 5 is a flow diagram illustrating operations for presenting database record information as the information will be on a specified date, according to example embodiments of the invention;

FIG. 6 is a flow diagram illustrating operations for creating records in a database, according to example embodiments of the invention;

FIG. 7 is a flow diagram illustrating operations for modifying records in a database, according to example embodiments of the invention; and

FIG. 8 is a flow diagram illustrating operations for deleting database records, according to example embodiments of the invention.

### DESCRIPTION OF THE EMBODIMENTS

System and methods for processing data using date information are described herein. This description of the embodiments is divided into four sections. The first section provides an introduction to embodiments of the invention, while the second section describes an example operating environment and system architecture. The third section describes example operations and the fourth section provides some general comments.

### Introduction

This section provides an introduction to embodiments of a system for processing data using date information. In one embodiment, the system includes a database of records, where each record includes fields for storing information. For example, the system's database can include a company's employee information. The database can include a record for each employee, where the record includes fields for storing employee-specific information, such as name, address, home telephone number, pay rate, etc.

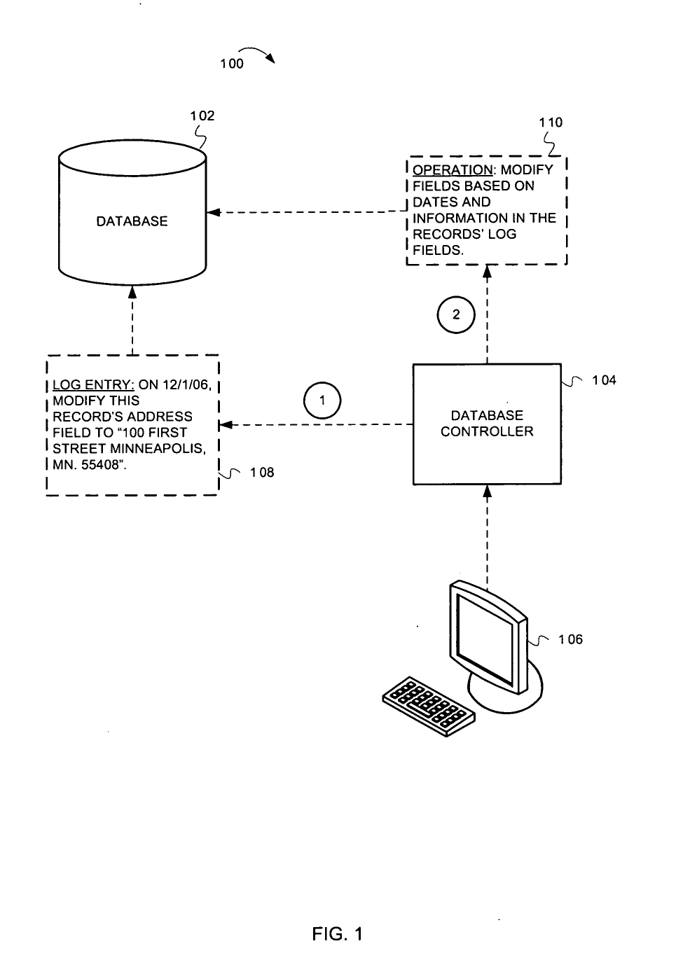

In addition to fields for storing employee-specific information, each record can include fields for logging all changes, past and future, associated with the record. For example, a record's log field can indicate that data in the record's name field was changed from “Jane Doe” to “Jane Smith” on a particular past date (e.g., Dec. 2, 2004). As another example, a record's log field can indicate that the record's pay rate field will change to “$20” on a given future date (e.g., Jan. 1, 2008). As a result, embodiments of the system need only the record itself to determine what changes have been made in the past and what changes are planned for the future. Thus, embodiments of the invention enable business software systems (and other systems) to schedule future database modifications and audit past database changes without maintaining separate database records related to scheduling and auditing. FIG. 1 presents some of these features in greater detail.

FIG. 1 is a diagram illustrating dataflow and operations for modifying a database record, according to embodiments of the invention. In FIG. 1, the system 100 includes a database 102, database controller 104, and user station 106. In one embodiment, the system 100 modifies a record in the database 102 in two stages.

At stage 1, the user station 106 receives, through a graphical user interface, changes associated with a particular employee record. The system 100 can represent the changes as an entry in the employee record's log field, where the entry indicates future changes that will be made to the record. For example, the log entry 108 can indicate that the record's address field will be changed to “100 First Street, Minneapolis, Minn., 55408” on a given future date (e.g., Dec. 1, 2006). The user station 106 sends the specified changes to the database controller 104, which in turn creates and stores the log entry 108 in the employee record (in the database 102).

At stage 2, the database controller 104 modifies the employee record's address field based on the record's log file. For example, on the given date (e.g., Dec. 1, 2006), the database controller 104 reads the log field and modifies the record's address field to “100 First Street, Minneapolis, Minn. 55408,” as prescribed in the record's log field. As a result, users can schedule a record for modification on a specified date, while the database controller 104 can modify the record using data in the record's log field.

While the discussion of FIG. 1 presents system components and operations for modifying fields of a database record, other embodiments include different components that perform different operations. This description continues with a discussion of an example system architecture and operating environment.

### System Architecture and Operating Environment

This section describes an example system architecture and operating environment with which embodiments of the invention can be practiced. Example operations associated with the system architecture will be described in the next section.

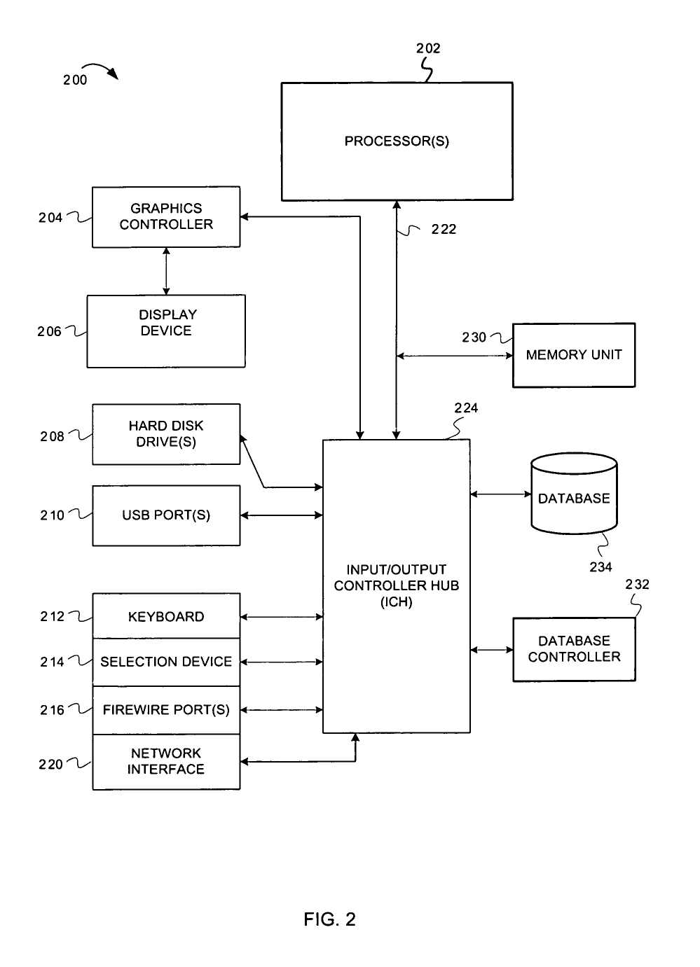

FIG. 2 illustrates an example computer system used in conjunction with certain embodiments of the invention. As illustrated in FIG. 2, computer system 200 comprises processor(s) 202. The computer system 200 also includes a memory unit 230, processor bus 222, and Input/Output controller hub (ICH) 224. The processor(s) 202, memory unit 230, and ICH 224 are coupled to the processor bus 222. The processor(s) 202 can be of any suitable processor architecture (e.g., CISC, RISC, etc.). The computer system 200 may comprise one, two, three, or more processors, any of which can execute a set of instructions in accordance with embodiments of the invention.

The memory unit 230 can store data and/or instructions and can comprise any suitable memory type, such as a dynamic random access memory (DRAM). The computer system 200 also includes hard disk drive(s) 208 and/or other suitable storage devices. A graphics controller 204 controls the display of information on a display device 206, according to embodiments of the invention.

The input/output controller hub (ICH) 224 provides an interface to I/O devices or peripheral components for the computer system 200. The ICH 224 can comprise any suitable interface controller to provide for a communication link to the processor(s) 202, memory unit 230, and/or any suitable device or component. In one embodiment, the ICH 224 provides suitable arbitration and buffering for each interface.

In one embodiment, the ICH 224 is connected to a database 234 and a database controller 232. The database 234 can include any hardware and/or software suitable for storing and retrieving data. Data within the database 234 can be organized according to any suitable model, such as a flat model, relational model, network model, object model, etc. The database controller 232 can include any hardware and/or software suitable for reading, writing, and modifying data stored in the database 232. In one embodiment, the database 234 can reside in the hard disk drive 208 and/or memory 230, while the database controller 232 can include hardware and/or machine-readable instructions residing in the memory unit 230 and/or the processor(s) 202. The database 234 and database controller 232 can work in concert with other hardware or software operating on the computer system 200. For example, the database 234 and database controller 232 can interface with business application software (not shown) executing on the computer system 200.

In one embodiment, the ICH 224 provides an interface to one or more suitable hard disk drives 208, DVD drives (not shown), or universal serial bus (USB) devices through one or more USB ports 210. In one embodiment, the ICH 224 also provides an interface to a keyboard 212, a mouse 214, and one or more suitable devices through one or more firewire ports 216. In one embodiment, the ICH 224 also provides a network interface 220 though which the computer system 200 can communicate with other computers and/or devices.

In one embodiment, the computer system 200 includes a machine-readable medium that stores a set of instructions (e.g., software) embodying one or more of the methods for processing data using data information described herein. Furthermore, software can reside, completely or at least partially, within memory unit 230 and/or within the processor(s) 202.

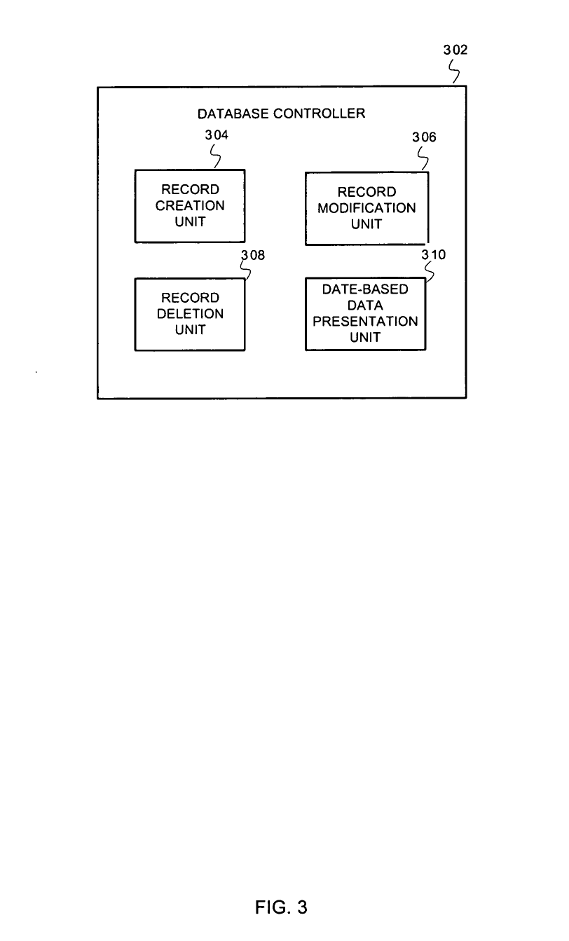

While FIG. 2 describes an example system architecture, FIG. 3 shows an embodiment of a database record controller. This description continues with a discussion of FIG. 3.

FIG. 3 is a block diagram illustrating a database controller, according to example embodiments of the invention. As shown in FIG. 3, the database controller 302 includes a record creation unit 304, record modification unit 306, record deletion unit 308, and a date-based data presentation unit 310. In one embodiment, the date-based data presentation unit 310 can present database information using date information. More specifically, the date-based data presentation unit 310 can determine a record's field values for given dates using information contained with the records' log fields. For example, the date-based data presentation unit 310 can determine what an Employee Record's EMPLOYEE NAME field will be on Dec. 5, 2005 or some other past/future date. The record creation unit 304 can create records in a database, whereas the record modification unit 306 can modify records in the database. The record deletion unit 308 can delete database records.

Any component of the database controller 302 can include machine-readable media including instructions for performing operations described herein. Machine-readable media includes any mechanism that provides (i.e., stores and/or transmits) information in a form readable by a machine (e.g., a computer). For example, machine-readable media include read only memory (ROM), random access memory (RAM), magnetic disk storage media, optical storage media, flash memory devices, etc. According to embodiments of the invention, the database controller's components can be other types of logic (e.g., hardware) for executing the operations described herein.

This description will continue with a discussion of database records.

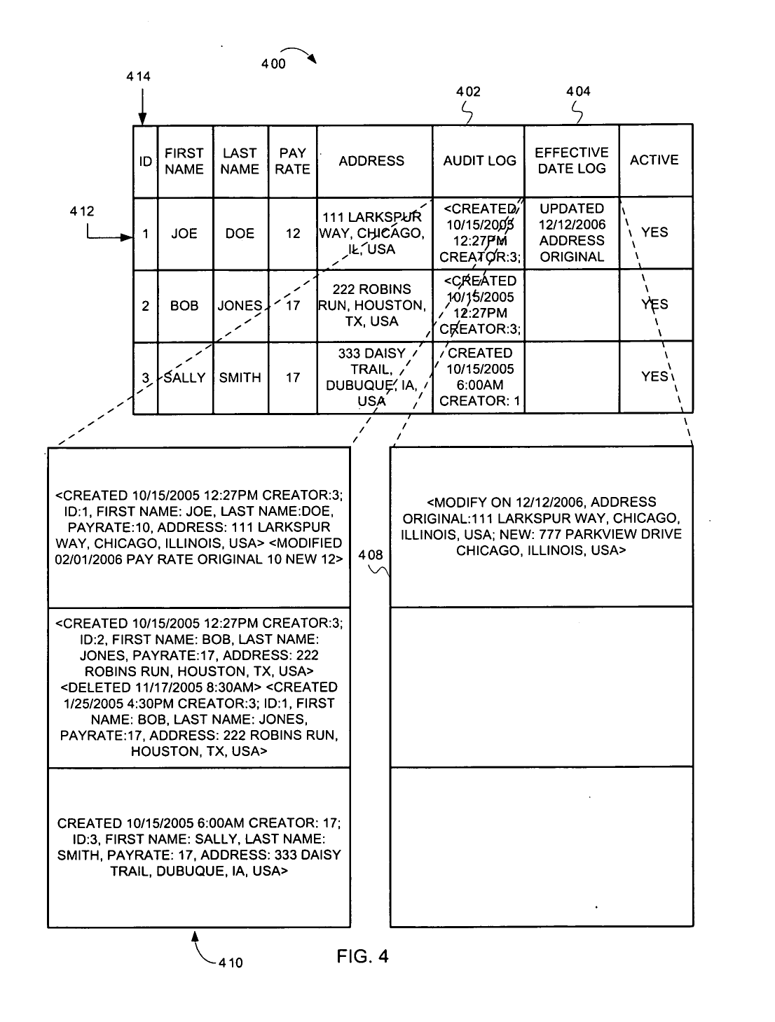

FIG. 4 is a block diagram illustrating database records, according to example embodiments of the invention. FIG. 4 shows a database table 400 divided into rows 412 and columns 414. The rows 412 represent records in a database (e.g., database 234), while the columns represent fields in each record. In FIG. 4, each record includes the following fields: ID field, FIRST NAME field, PAY RATE field, ADDRESS field, AUDIT LOG field, EFFECTIVE DATE LOG field, and ACTIVE field.

A record's audit log field 402 documents creation and modification of the record. In one embodiment, the audit log fields 402 can include information about when, how, why and by whom the record was created and/or modified. The audit log fields 402 can also include the record's initial field values. In one embodiment, the audit log fields 402 can include the audit log entries 410. As shown in FIG. 4, a record's audit log field 402 can includes the following example information:
<CREATED Oct. 15, 2005 12:27 PM CREATOR:3; ID:2, FIRST NAME: BOB, LAST NAME: JONES, PAYRATE:17, ADDRESS: 222 ROBINS RUN, HOUSTON, Tex., USA><DELETED Nov.17, 2005 8:30 AM><CREATED Jan. 25, 2005 4:30 PM CREATOR:3; ID:1, FIRST NAME: BOB, LAST NAME: JONES, PAYRATE:17, ADDRESS: 222 ROBINS RUN, HOUSTON, Tex., USA>.

The effective date log fields 404 can indicate how a record's fields will be changed in the future. For example, a record's effective date log field 404 can include the following example information (see effective date log entries 408):
<MODIFY ON Dec. 12, 2006 ADDRESS ORIGINAL:111 LARKSPUR WAY, CHICAGO, Ill., USA NEW: 777 PARKVIEW DRIVE CHICAGO, Ill., USA>.

In one embodiment, the audit log fields 402 and effective date log fields 404 include information formatted according to the Extensible Markup Language (XML) format. Other embodiments can employ XML and/or other data formats, such as binary encoding, ASCII, HTML, or any other suitable data format. In one embodiment, the audit log fields 402 and effective date log fields 404 can be stored in the database 234 as Large Objects (LOBs), such as Character Large Objects (CLOBs) and Binary Large Objects, which are suited for storing several megabytes of data or much more.

### System Operations

This section describes operations performed by embodiments of the invention. In certain embodiments, the operations are performed by instructions residing on machine-readable media (e.g., software), while in other embodiments, the methods are performed by hardware or other logic (e.g., firmware).

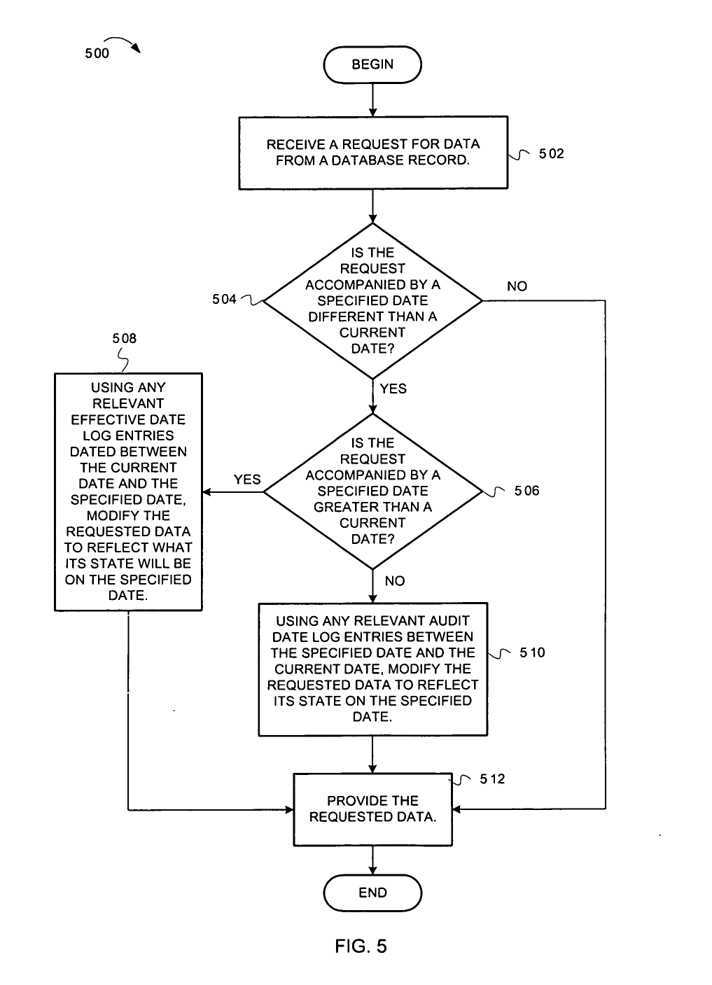

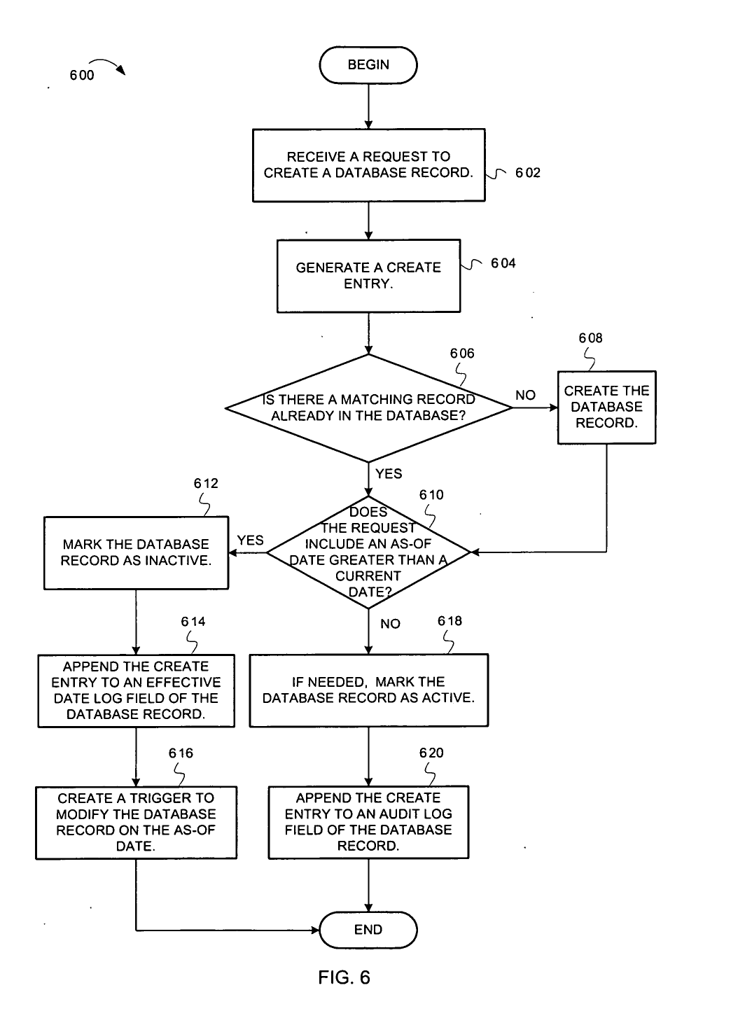

In this section, FIGS. 5-8 will be discussed. In particular, FIG. 5 describes operations for presenting database data as the data will be on a specified date, while FIG. 6-8 describe operations creating, modifying, and deleting database records. The flow diagrams of FIGS. 5-8 will be described with reference to the example embodiments of FIGS. 2-4. This description continues with a discussion of FIG. 5.

FIG. 5 is a flow diagram illustrating operations for presenting database record information as the information will be on a specified date, according to example embodiments of the invention. The flow diagram 500 commences at block 502.

At block 502, a database controller's date-based data presentation unit 310 receives a request for data associated with a record in the database 234. For example, the request could be for a value of the PAY RATE field in JOE DOE's record (see 412 of FIG. 4). In one embodiment, the request is received from a user interface module, while in other embodiments the requested can be received from other application programs (e.g., a business reporting application). The flow continues at block 504.

At block 504, the date-based data presentation unit 310 determines whether the request is accompanied by a specified date that differs from the current date. The specified date designates a date (past, present, or future) associated with the requested data. For example, the specified date could be Nov. 15, 2005, whereas the current date is Jan. 1, 2006. If the request is accompanied by a specified date that differs from the current date, the flow continues at block 506. Otherwise, the flow continues at block 512.

At block 506, the date-based data presentation unit 310 determines whether the specified date is greater than the current date (i.e., a future date). If the specified date is greater than the current date, the flow continues at block 508. Otherwise, the flow continues at block 510.

At block 510, using the record's audit log entries between the specified date and the current date, the date-based data presentation unit 310 determines a value for the requested data as of the specified date. For example, the date-based data presentation unit 310 uses audit log entries 410 associated with JOE DOE's record 412 to determine the value of the PAY RATE field on Nov. 15, 2005. Based on the audit log entries 410, the date-based data presentation unit 310 would determine that JOE DOE's PAY RATE field was “10” on Nov. 15, 2005. The flow continues at block 512.

At block 508, using relevant effective date log entries between the specified date and the current date, the date-based data presentation unit 310 determines a value for the requested data on the specified date. Because the specified date noted above would not lead to block 508 (see discussion of block 504), consider an example where the specified date is Feb. 28, 2006 and the current date is Jan. 1, 2006. In such an instance, the date-based data presentation unit 310 would use effective date log entries 410 associated with JOE DOE's record 412 to determine that the value of the PAY RATE field on Feb. 28, 2006 is “12” (see block 410 of FIG. 4). The flow continues at block 512.

At block 512, the date-based data presentation unit 310 provides the requested data. For example, the date-based data presentation unit 310 transmits a value of the JOE DOE record's PAY RATE field on the specified date. The date-based data presentation unit 310 can provide the field value to a business application running on an external system or to a database reporting application running on the computer system 200.

Therefore, the database controller 232 can use a record's audit log and effective date log fields to determine a record's field values on specified dates (past or future). While FIG. 5 describes operations for date-sensitive database record processing, FIG. 6 describes operations for creating records in a database.

FIG. 6 is a flow diagram illustrating operations for creating records in a database, according to example embodiments of the invention. The discussion of FIG. 6 will show how embodiments of the invention can schedule record creation to occur on specified future dates. The discussion will also describe operations for recording, in a record's effective date log field, information for initializing the record's field values upon creation. The flow diagram 600 commences at block 602.

At block 602, the database controller's record creation unit 304 receives a request to create a database record. In one embodiment, the record creation unit 304 receives the request from a database application (not shown) running on the computer system 200 or software running on an external system. In one embodiment, the request includes a specific date, as well as information (e.g., a primary key) for inclusion in the record upon its creation. The flow continues at block 604.

At block 604, the record creation unit 304 generates a “create” entry. In one embodiment, the “create” entry will be inserted into one of the log fields of the record being created. In one embodiment, create entries can include information received with the request, such as dates, times, user identifiers, primary key values, etc. Moreover, create entries can include data in an XML format, HTML format, binary format, etc. In one embodiment, the create entries can include data shown in FIG. 4's audit log fields 402. For example, the create entries can be of the form “<CREATED creation data>”, where creation data can be any data about who, when, how, and why the record was created. The flow continues at block 606.

At block 606, the record creation unit 304 determines whether there is a matching record already in the database 234. In one embodiment, the record creation unit 304 searches the database 234 for a record having information (e.g., a primary key) matching the information received with the request (see discussion of block 602). If there is not a matching record already in the database 234, the flow continues at block 608. Otherwise, the flow continues at block 610.

At block 608, the record creation unit 304 creates a record 412 in the database 234. In one embodiment, the new record has no values in its fields. In another embodiment, the new record is created with a value in its primary key field (e.g., the employee ID field) and any other values identified in the information received with the request (see discussion of block 602).

At block 610, the record creation unit 304 determines whether the request (received at block 602) includes a specified date that is greater than the current date. That is, the record creation unit 304 determines whether the specified date is a future date. If the request includes a specified date greater than the current date, the flow continues at block 612. Otherwise, the flow continues at block 618.

At block 612, the record creation unit 304 marks the matching database record as “inactive.” For example, the record creation unit 304 marks the matching record's ACTIVE field (see FIG. 4) to “NO.” In one embodiment, the database controller 232 does not read from or write to fields of inactive records, except as described in this flow. The flow continues at block 614.

At block 614, the record creation unit 304, appends the “create” entry to an effective date log field of the database record. For example, the record creation unit 304 can insert the create entry into an effective log field 404 for JOE DOE's record in the table 400 (see FIG. 4). As noted above, the create entry can include information (e.g., a primary key etc.) that can be used to modify the record in the future. The flow continues at block 616.

At block 616, the record creation unit 304 creates a trigger that will modify the database record on the specified date. In one embodiment, the trigger will cause the record creation unit 304 to mark the record as “active” and to modify the record's fields according to the information stored in the record's effective date log field 404. In one embodiment, triggers can include SQL code or other programming language code that is stored in the database 234. From block 616, the flow ends.

At block 618, the record creation unit 304 marks the database record as “active,” if needed. The flow continues at block 620.

At block 620, the record creation unit 304 appends the “create” entry to an audit log field 402 of the database record. From block 620, the flow ends.

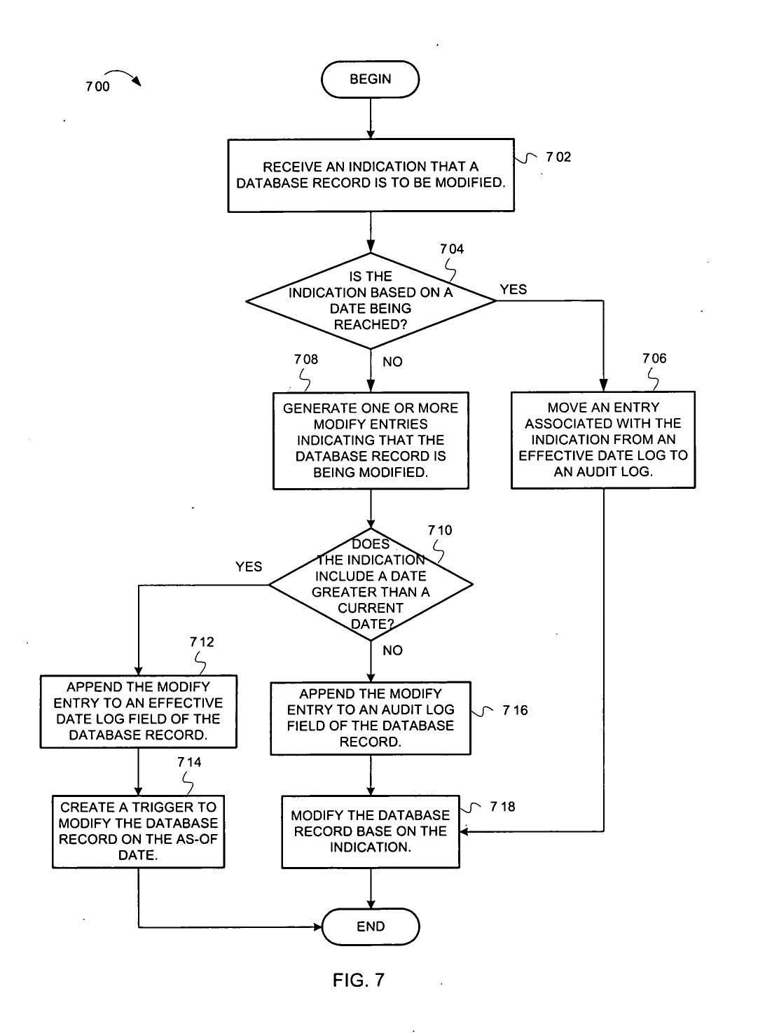

While FIG. 6 describes operations for creating database records, FIG. 7 describes operations for modifying database records. This description continues with a discussion of FIG. 7.

FIG. 7 is a flow diagram illustrating operations for modifying records in a database, according to example embodiments of the invention. The discussion of FIG. 7 will show how embodiments can use effective date logs for modifying records on future dates. The discussion will also describe operations for recording, in a record's audit log field, how the record has been modified. The flow 700 begins at block 702.

At block 702, the record modification unit 306 receives an indication that a database record is to be modified. In one embodiment, indication includes a date indicating when the modification should be performed. Additionally, the indication can specify particular modifications, such as modifying a record's PAY RATE field from “10” to “12.” In one embodiment, the record modification unit 306 can receive the indication as a result of a trigger (see discussion of block 616). In another embodiment, the indication can be a result of other database operations performed by any suitable database application (not shown). The flow continues at block 704.

At block 704, the record modification unit 306 determines whether the indication is based on a date being reached. In one embodiment, if the indication is based on reaching a date, the indication can be the result of a trigger. If the indication is not based on reaching a date, the indication can result from a database administrator modifying records using a database application. In another embodiment, the indication can result from any suitable application program modifying records in the database 234. If the indication is based on reaching a date, the flow continues at block 706. Otherwise, the flow continues at block 708.

At block 706, the record modification unit 306 moves an entry from the record's effective date log 404 to the record's audit log 402, where the entry is associated with the indication. In an alternative embodiment, the record modification unit 306 can delete an entry from the record 's effective date log 404 and create a new entry in the record's audit log 402. The flow continues at block 718.

At block 708, the record modification unit 306 generates one or more “modify” entries indicating how the database record is being modified. For example, as shown in FIG. 4, a “modify” entry can take the following form: <MODIFIED Feb. 1, 2006 PAY RATE ORIGINAL 10 NEW 12>. This example modify entry indicates that a record's PAY RATE field was modified from “10” to “12” on Feb. 1, 2006. In one embodiment, modify entries can take any suitable form. The flow continues at block 710.

At block 710, the record modification unit 306 determines whether the indication includes a date greater than the current date (see discussion of block 702). If the date is greater than the current date, the flow continues at block 712. Otherwise, the flow continues at block 716.

At block 712, the record modification unit 306, appends the “modify” entry to an effective date log field 404 of the database record 412 (see audit log entries 410). The flow continues at block 714.

At block 714, the record modification unit 306 creates a trigger to modify the database record on the date specified in the indication. In one embodiment, the trigger will send a record modification indication to the record modification unit 306, where the record modification unit 306 will process the indication according to the flow 700. From block 714, the flow ends.

At block 716, the record modification unit appends the “modify” entry to an audit log field 402 of the database record 412. The flow continues at block 718.

At block 718, the record modification unit 306 modifies the database record based on the indication. For example, based on the indication, the record modification unit 306 can modify JOE DOE's PAY RATE field from “10” to “12.” From block 718, the flow ends.

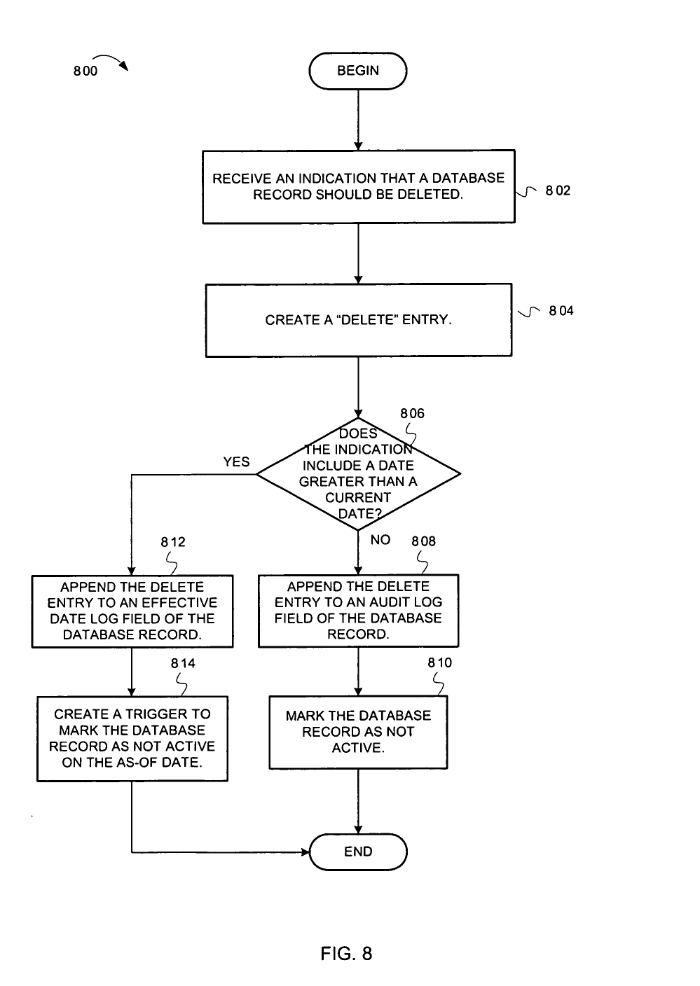

While FIG. 7 presents operations for modifying database records, FIG. 8 presents operations for deleting records from a database. The discussion of FIG. 8 will describe how embodiments can use effective date log fields for deleting database records at some future date. Additionally, the discussion will explain how embodiments can use audit log fields to track record deletions. This description continues with a discussion of FIG. 8.

FIG. 8 is a flow diagram illustrating operations for deleting database records, according to example embodiments of the invention. The flow 800 begins at block 802.

At block 802, the record deletion unit 308 receives an indication that a database record should be deleted. In one embodiment, the indication includes a date on which the deletion is to take effect. In one embodiment, the indication is a result of a trigger. In another embodiment, the indication comes from a database application or other application program running on the computer system 200. The flow continues at block 804.

At block 804, the record deletion unit 308 creates a “delete” entry. In one embodiment, the delete entry can take the following form: <DELETE ID=1 2/28/05>. In other embodiments, the delete entries can take any suitable form. The flow continues at block 806.

At block 806, the record deletion unit 308 determines whether the indication includes a date greater than the current date. If the indication includes a date greater than the current date, the flow continues at block 812. Otherwise, the flow continues at block 808.

At block 808, the record deletion unit appends the “delete” entry to the record's audit log field 402 (see audit log entries 410). The flow continues at block 810.

At block 810, the record deletion unit 308 marks the record as “inactive.” For example, the record deletion unit 308 marks the record's ACTIVE field (see FIG. 4) to “NO.” From block 810, the flow ends.

At block 812, the record deletion unit 308 appends the “delete” entry to an effective date log field 404 of the database record (see FIG. 4). The flow continues at block 814.

At block 814 the record deletion unit 380 creates a trigger that will mark the database record as “inactive” on the date specified in the indication received at block 802. In one embodiment, the record controller 232 does not read from or write to inactive records. Thus, inactive records are treated almost as if they are deleted form the database 234. From block 814, the flow ends.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “example embodiment” means that the embodiment being referred to serves as an example or illustration.

Herein, block diagrams illustrate example embodiments of the invention. Also herein, flow diagrams illustrate operations of the example embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagrams depict serial operations, certain embodiments could perform certain of those operations in parallel.

1. An apparatus comprising:
a record creation unit configured to create a database record, the database record including a first field indicating past operations performed on the database record, and the database record including a second field indicating future operations to be performed on the database record.

2. The apparatus of claim 1 further comprising:
a date-based data presentation unit configured to determine a date, the date-based data presentation unit also configured to obtain data from the database record, to modify the data using entries of the first field or the second field, and to present the data, the data reflecting a state of the database record on the date.

3. The apparatus of claim 1 further comprising:
a record modification unit configured to modify the database record and to record the modification in the first field.

4. The apparatus of claim 1 further comprising:
a record modification unit configured to record, in the second field, a modification indicator indicating a modification of the database record to be performed on a future date.

5. The apparatus of claim 4, wherein the record modification unit is further configured to modify, based on the modification indicator, the database record on the future date.

6. The apparatus of claim 1 further comprising:
a record deletion unit to cause the database record to become inactive as a result of one of the future operations indicated in the second field.

7. The apparatus of claim 1 further comprising:
a record deletion unit to cause the database record to become inactive and record, in the first field, an indication of the operation.

8. The apparatus of claim 1 further comprising:
a record deletion unit to record, in the second field, a deletion indicator indicating that the database record should be marked inactive on a future date.

9. The apparatus of claim 1, wherein the first field and the second field are character large object (CLOB) data types.

10. A method comprising:
determining an operation to be performed on a database record;
determining whether the operation should be performed on a present date or on a future date;
if the operation should be performed on a present date, inserting an entry into an audit log field of the database record, wherein the audit log field is configured to include one or more entries indicating one or more operations that have been performed on the database record; and
if the operation should be performed on a future date, inserting an entry into an effective date log field of the database record, wherein the effective date log field is to configured to include one or more entries indicating one or more operations that should be performed on the database record in the future.

11. The method of claim 10 further comprising:
if the operation should be performed on the future date, creating a trigger to modify the database record on the future date.

12. The method of claim 10, wherein the entry indicates that only one field of the database record is being modified.

13. The method of claim 10, wherein the entry indicates that many fields of the database record are being modified.

14. The method of claim 10, wherein the operation is a creation operation, the method further comprising:
creating the database record; and
if the operation should be performed at the future date, causing the database record to indicate an inactive status.

15. The method of claim 10, wherein the operation is a delete operation, the method further comprising:
if the operation should be performed at the present date, modifying the database record to indicate an inactive status.

16. The apparatus of claim 10, wherein the audit log field and the effective date log field are character large object (CLOB) data types.

17. A method comprising:
receiving a request for data from a database record;
determining whether the request is associated with a date different than a current date;
if the request is associated with a future date, using an effective date log field of the database record to modify the data to reflect a future state of the database record as of the date, wherein the effective date log field is configured to include one or more entries indicating one or more operations to be performed on the database record;
if the request includes a past date, using an audit log field of the database record to modify the data to reflect a past state of the database record as of the date, wherein the audit log field is configured to include one or more entries indicating one or more operations previously performed on the database record; and
providing the data.

18. The method of claim 17, wherein if the request is associated with a future date, the modifying is performed using entries of the effective date log field that are dated between the current date and the date.

19. The method of claim 17, wherein if the request is associated with a past date, the modifying is performed using entries of the audit log field that are dated between the date and the current date.

20. The method of claim 17, wherein the data is requested for use in business data auditing, report generating, graphical data presentation, or calculation involving the data.
